(19) United States
(12) Patent Application Publication
(10) Pub. No.: US 2005/0062967 A1
(43) Pub. Date: Mar. 24, 2005

(54) Position measurement mehtod, exposure method, exposure device, and manufacturing method of device

(75) Inventor: Mitsuru Kobayashi, Kumagaya-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/992,804

(22) Filed: Nov. 22, 2004

Related U.S. Application Data
(63) Continuation of application No. PCT/JP03/06941, filed on Jun. 2, 2003.

(30) Foreign Application Priority Data
May 31, 2002 (JP) 2002-159660

(51) Int. Cl. G01B 11/00

(52) U.S. Cl. 356/400

(57) ABSTRACT

With this position measurement method, a mark which has been formed upon an object is illuminated with an illumination beam, a beam which is generated from this mark is picked up via an observation system, and the resultant image signal is signal processed so as to measure positional information which is related to the mark. This signal processing is performed based upon information related to the noise which is included in the component dependent upon the amount of light which is included in the image signal, and upon said image signal. As a result, it is possible to measure the positional information for the mark with good accuracy, even if noise is included in the image signal.

### BACKGROUND OF THE INVENTION

1. Field of the Invention

The present invention relates to a position measurement method for measuring positional information related to the position of a mark by picking up an image via an observation system of a mark which is formed upon an object, and by performing signal processing upon this image signal; and in particular relates to a technique which is utilized in a exposure method and a exposure device which are used in a manufacturing process for a device such as a semiconductor element or a liquid crystal display element or the like. This application is a continuation application based on PCT/JP2003/06941 designating U.S.A. filed on Jun. 2, 2003.

2. Description of the Related Art

While performing a manufacturing process for an electronic device such as a liquid crystal display element or the like, a plurality of layers of a circuit pattern are formed over one another in a predetermined positional relationship upon a substrate (a wafer or a glass plate or the like). In order to do this, during exposure of the second and subsequent layers of the circuit pattern onto the substrate by an exposure device, it is necessary to perform positional alignment at high accuracy between the pattern of a mask (or a reticle) and the pattern which is already formed upon the mask.

Thus, a mark for positional alignment is formed upon the substrate or the mask, positional information related to the position of this mark is measured, and the above positional alignment is performed based upon this positional information.

As a technique for position measurement for such a mark, there is a method of obtaining the positional information for the mark by irradiating an illumination beam at a mark upon the substrate or upon the mask, picking up an optical image thereof via an observation system which comprises an image pick up device such as a CCD camera or the like, and signal processing the resultant image signal.

With a position measurement method which employs such an observation system, it sometimes happens that noise generated by the optical system is included in the image signal. In such a case, there is a possibility that measurement error will occur due to the influence of such noise which is included in the image signal.

The present invention has been conceived in the light of the above circumstances, and it takes as its objective to provide a position measurement method which is able to measure positional information for a mark with good accuracy, even if noise is included in the image signal.

Furthermore, the present invention takes as another of its objectives to provide a exposure method and a exposure device, which can enhance the accuracy of exposure to light.

Yet further, the present invention takes as another of its objectives to provide a method of manufacturing a device, with which it is possible to anticipate enhancement of the accuracy of the pattern which is produced.

### SUMMARY OF THE INVENTION

With the present invention, in a position measurement method in which a mark (RM1, RM2) which has been formed upon an object (R) is illuminated with an illumination beam, a beam which is emitted from this mark (RM1, RM2) is picked up via an observation system (22A, 22B), and the resultant image signal is signal processed so as to measure positional information which is related to the mark (RM1, RM2): the signal processing is performed based upon information related to the noise which is included in the image signal and includes component dependent upon the amount of light, and upon the image signal.

With this position measurement method, it is possible to correct for the influence of noise during position measurement by performing the signal processing based upon the information which is related to the noise that is included in the image signal, in addition to the image signal of the mark. Since the noise includes a component which is dependent upon the amount of light, it is possible to measure the positional information for the mark with good accuracy by correcting for its influence.

In this case, it is possible easily to compensate for the influence of noise in the image signal by measuring the noise which includes the component dependent upon the amount of light in advance, before performing signal processing upon the image signal.

Furthermore, it becomes possible always to compensate accurately for the influence of the noise by performing the measurement of the noise again, according to the characteristic of variation with the passage of time of the component which is dependent upon the amount of light.

The measurement of the noise which includes the component which is dependent upon the amount of light is performed by, for example, illuminating a non mark region upon the object (R) which is different from the mark region in which the mark (RM1, RM2) is formed is illuminated with an illumination beam, and picking up this non mark region via the observation system (22A, 22B).

Furthermore, when the mark (RM1, RM2) includes a plurality of mark elements, then it is possible to perform more accurate measurement of the component of the noise which is dependent upon the amount of light and which exerts an influence upon positional measurement by, among the plurality of mark elements, illuminating a region which includes the mark elements other than the object of measurement with the illumination beam.

Yet further, it becomes possible to perform stabilized positional measurement over a long time period by measuring an environmental factor which exerts an influence upon the noise, and by performing measurement again of the noise, based upon the result of this measurement.

The noise in which in the component dependent upon the amount of light is included may, for example, be generated because of the beam which is emitted from the mark (RM1, RM2) passing through the observation system (22A, 22B).

As a cause of generation of noise in the observation system (22A, 22B), for example, there may be cited interference fringes which are generated by a mirror (73, 86) or by a cover glass of an image pick up device (78), or variations of the sensitivity between a plurality of picture elements of the image pick up device (78), or the like.

Furthermore, the noise may include, apart from the component which is dependent upon the amount of light, also a component which is independent of the amount of light. In this case, it will be acceptable to measure the component which is dependent upon the amount of light included in the noise in advance, in the state in which the illumination beam is not being observed by the observation system (22A, 22B), before performing signal processing upon the image signal.

When the noise includes a component which is dependent upon the amount of light and also a component which is independent of the amount of light, then the influence of noise upon the image signal may be well corrected by the signal processing including a procedure of subtracting the component of the noise which is independent of the amount of light from the image signal, or a procedure of subtracting the component of the noise which is dependent upon the amount of light from the image signal, or of dividing it thereinto.

Or, the influence of noise upon the image signal may be well corrected by the signal processing including a procedure of subtracting the component of the noise which is independent of the amount of light from the component of the noise which is dependent upon the amount of light, and dividing the processing result into the processing result of subtracting the component of the noise which is independent of the amount of light from the image signal.

Furthermore, with the present invention, in an exposure method in which a pattern which has been formed upon a mask (R) is transcribed onto a substrate (W), a mark (RM1, 9M2, WFM1, WFM2) which has been formed upon the mask (R) or upon the substrate (W) is illuminated with an illumination beam, a beam which is emitted from this mark is picked up via an observation system (22A, 22B), and, based upon the image signal of the observation system (22A, 22B) and information which is related to the noise which is included in this image signal and includes a component dependent upon the amount of light, the image signal is signal processed so as to measure positional information which is related to the mark, and the position of the mask (R) or of the substrate (W) is set to a position for exposure to light, based upon the positional information which has been measured.

Or, with the present invention, in an exposure device which transcribes a pattern which has been formed upon a mask (R) onto a substrate (W), there are included: an observation system (22A, 22B) which illuminates a body with an illumination beam, and picks up a beam which has been emitted from this body, and a signal processing member (13) which picks up a mark (RM1, RM2, WFM1, WFM2) which has been formed upon the mask (R) or upon the substrate (W) via the observation system (22A, 22B), and signal processes the image signal thereof and measures positional information which is related to the position of the mark; and a position determination member (24) which, based upon the positional information which has been measured, sets the position of the mask (R) or of the substrate (W) to a position for exposure to light; wherein the signal processing member (13) performs the signal processing based upon information which is related to the noise which is included in this image signal and includes a component dependent upon the amount of light, and upon the image signal.

According to this exposure method and this exposure device, since it is possible to measure the positional information for the mark with good accuracy, it is possible to anticipate an enhancement of the accuracy of exposure to light.

Furthermore, the method of manufacturing a device according to the present invention may include, a process of transcribing a device pattern which is formed upon a mask onto a substrate by using the above described exposure method or the above described exposure device.

According to this method of manufacturing a device, the accuracy of exposure to light is high, so that it is possible to anticipate an enhancement of pattern accuracy.

### BRIEF DESCRIPTION OF THE DRAWINGS

FIG. 1 is a figure showing the schematic structure of a reduction projection type exposure device which is used for manufacture of a semiconductor device.

FIG. 2 is a figure showing the structure of a reticle alignment microscope.

FIG. 3 is a figure showing an example of the structure of a reticle mark.

FIG. 4 is a figure showing the structure of a wafer reference mark.

FIG. 5 is a figure showing an image of a reticle mark and a wafer reference mark which have been focused into images at the same time upon the light reception surface of a camera for observation, and also showing the image signal thereof (the signal photoelectrically converted therefrom).

FIG. 6 is a flow chart showing an example of a procedure for the operation of measuring the position of a mark.

FIG. 7A is a figure for explanation of the influence which noise included in the image signal exerts upon the measurement of the position of the mark.

FIG. 7B is another figure for explanation of the influence which noise included in the image signal exerts upon the measurement of the position of the mark.

FIG. 8A is a figure showing, when the marks (the reticle mark and the wafer reference mark) have been observed by the camera for observation, the image signal (i.e., the signal photoelectrically converted therefrom).

FIG. 8B is a figure showing signal waveform data when a component independent of the amount of light of noise included in the image signal shown in FIG. 8A has been measured.

FIG. 8C is a figure showing signal waveform data when a component dependent upon the amount of light of noise included in the image signal shown in FIG. 8A has been measured.

FIG. 9 is a figure showing waveform data which has been produced by performing signal processing upon the image signal shown in FIG. 8A based upon a predetermined algorithm.

FIG. 10 is a figure showing waveform data which has been produced by performing signal processing upon the image signal shown in FIG. 8A based upon a predetermined algorithm.

FIG. 11 is a figure showing waveform data which has been produced by performing signal processing upon the image signal shown in FIG. 8A based upon a predetermined algorithm.

FIG. 12 is a figure showing an example of another preferred embodiment of mark position measurement operation.

FIG. 13 is a figure showing an example of yet another preferred embodiment of mark position measurement operation.

FIG. 14 is a flow chart showing the process of manufacture of a micro device using an exposure device according to a preferred embodiment of the present invention.

### DETAILED DESCRIPTION OF THE PREFERRED EMBODIMENTS

In the following, various preferred embodiments of the present invention will be explained with reference to the figures.

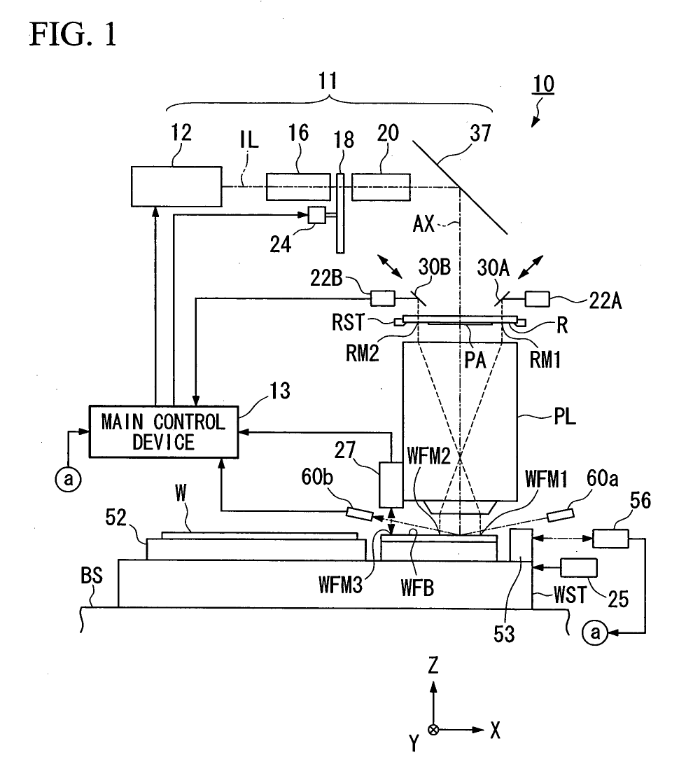

FIG. 1 is a figure showing the schematic form the structure of a reduction projection type exposure device which is used for manufacture of a semiconductor device. This projection exposure device 10 is a scanning type exposure device of the step-and-scan type, which transcribes a circuit pattern which has been formed upon a reticle R (which acts as a mask) into each shot region upon a wafer W (which acts as a substrate) while synchronously shifting the reticle R and the wafer W in a one dimensional direction.

This projection exposure device 10 comprises an illumination system 11 which includes a light source 12, a reticle stage RST which holds the reticle R, a projection optical system PLwhich projects an image of the pattern which is formed upon the reticle R onto the wafer W, a wafer stage WST which acts as a substrate stage for supporting the wafer W, a pair of reticle alignment microscopes 22A and 22B which serve as observation member, a wafer alignment sensor 27, a main focus detection system (60a, 60b), and a control system and the like.

The illumination system 11, apart from comprising an optical system 16 for making the intensity of illumination uniform which includes a light source 12 which, for example, may be an excimer laser, a lens for beam shaping, and an optical integrator (a fly-eye lens) and the like, also comprises a plate (a revolver) 18 which acts as a throttling device for the illumination system, a relay optical system 20, a reticle blind which is not shown in the drawings, a deflection mirror 37, a condenser lens system which is not shown in the drawing, and the like. In the following, the various structures of the illumination system will be explained, along with their operation. With regard to the illumination beam IL (light from an excimer laser which utilizes KrF, ArF or the like) which is emitted from the light source 12, equalization of its luminous flux distribution and speckle reduction or the like is performed by the optical system 16 for making the illumination intensity uniform. acceptable to utilize an extra-high pressure mercury lamp as the light source 12. In such a case, along with an emission line in the ultraviolet region such as the g line or the i line or the like being utilized for the illumination beam, the opening and closing of a shutter which is not shown in the figures is controlled by said main control device 13.

The illumination system aperture stop plate 18 which consists of a circular plate shaped member is disposed at the exit aperture portion of the optical system 16 for making the illumination intensity uniform, and, upon this illumination system aperture stop plate 18, at almost equal angular spacing, for example, there may be disposed: an aperture stop which consists of a normal type of circular shaped aperture; an aperture stop which consists of a small circular shaped aperture, and which is for reducing the value of o, which is the coherence factor; an aperture stop which is formed in a ring shape for providing ring illumination; an aperture stop which is provided with a plurality of apertures which are disposed eccentrically, for employing a deformed light source method; and the like; none of which are shown in the figures. This illumination system aperture stop plate 18 is rotationally driven by a drive system 24 such as a motor or the like which is controlled by the main control device 13, and thereby any one of the above-mentioned aperture stop may be selectively positioned upon the optical path of the illumination beam IL.

A relay optical system 20 is provided upon the optical path of the illumination beam IL after the illumination system aperture stop plate 18, via a blind or the like which is not shown in the figures. The surface upon which this blind is disposed is in conjugate relationship with the reticle R. A deflection mirror 37 which reflects the illumination beam through the relay optical system 20 back towards the reticle R is disposed upon the optical path of the illumination beam IL after the relay optical system 20, and a condenser lens which is not shown in the drawings is disposed upon the optical path of the illumination beam IL after this deflection mirror 37. When the illumination beam IL passes through the relay optical system 20, after having been regulated to an illumination region upon the reticle R by the blind or the like which is not shown in the drawings, said illumination beam IL is deflected in the vertically downward direction in the figure by the mirror 37, and, via the condenser lens which is also not shown in the drawings, illuminates illumination beam IL is deflected in the vertically downward direction in the figure by the mirror 37, and, via the condenser lens which is also not shown in the drawings, illuminates a pattern region PA within the above described illumination region upon the reticle R with an evenly distributed intensity of illumination.

The reticle R is sucked down onto the reticle stage RST and held there by a vacuum chuck or the like which is not shown in the drawings. The reticle stage RST can be shifted in two dimensions within a horizontal plane (the XF plane), and, after the reticle R has been loaded upon the reticle stage RST, the position of the central point of the pattern region PA of the reticle R is fixed so as to coincide with the optical axis AX. The position determination operation of the reticle stage RST, when it is in this state, is performed by a drive system which is not shown in the drawings, under the control of the main control device 13. It should be understood that the reticle alignment for initially setting the reticle R will be described in detail hereinafter. Furthermore, the reticle R is changed over, as appropriate, by the use of a reticle changing over device which is not shown in the figures.

The projection optical system PL comprises a plurality of lens elements which have an optical axis AX along a common Z axis direction which is disposed so as to be optically arranged telecentrically upon both sides. Furthermore, a projection optical system having a projection ratio of, for example, ¼ or ⅕ may be used for this projection optical system PL. Due to this, as described above, when the illumination region upon the reticle R is illuminated by the illumination beam IL, the pattern which is formed upon the pattern surface of the reticle R is projected by the projection optical system PL in reduced form upon the wafer W whose surface is coated with a resist (a light sensitive material), and thereby a reduced image of a circuit pattern which is formed upon the reticle R is transcribed into each of the shot regions upon the wafer W.

The wafer stage WST is carried upon a surface plate (the stage surface plate BS) which is disposed below the projection optical system PL. This wafer stage WST actually comprises an XY stage which can be shifted two dimensionally within a horizontal plane (the XY plane) and a Z stage which is mounted upon this XY stage and which is capable of minute movement in the direction of the optical axis (the Z direction), however, in FIG. 1, to represent these arrangements, only the wafer stage WST is shown. In the following explanation, it will be supposed that this wafer stage WST is driven by the drive system 25, not only in the two dimensions X and Y along the upper surface of the stage surface plate BS, but also through a minute range (for example about 100 μm) in the direction of the optical axis AX. It should be understood that the surface of the stage surface plate BS has been processed so as to be planar, and that, moreover, a uniform plating process has been performed upon it using a low reflectivity ratio material (black chrome or the like).

Furthermore, the wafer W is supported by vacuum suction adhesion or the like upon the wafer stage WST via a wafer holder 52. The position in two dimensions of the wafer stage WST is constantly detected, via a shift mirror 53 which is fixed upon said wafer stage WST, by a laser interferometer 56 at a predetermined resolution (for example about 1 nm). The output of this laser interferometer 56 is provided to the main control device 13, and the drive system 25 is controlled by the main control device 13 based upon this information. By this type of closed loop control system, for example, when the transcription by exposure to light and scanning of the pattern which is formed upon the reticle R onto one shot region upon the wafer W has been completed, the wafer stage WST is stepped up to the initial position for exposure for the next shot. Furthermore, when exposure to light for all of the shot positions has been completed, the wafer W is changed over for another wafer W by a wafer changeover device which is not shown in the drawings. It should be understood that this wafer change over device is disposed at a position which is exterior to the wafer stage WST, and comprises a wafer transportation system such as a wafer loader or the like which performs receipt and transfer of the wafers W.

Furthermore, the position in the Z direction of the surface of the wafer W is measured by a main focus detection system. As such a main focus detection system, there is utilized a focal point detection system of the oblique light incidence type which comprises an illumination optical system 60a which illuminates focused light rays or parallel light rays for forming an image of a pinhole or a slit from a slanting direction with respect to the optical axis AX towards an image focusing-plane of the projection optical system PL, and a light reception optical system 60b which receives the focused light rays or the parallel light rays which have been reflected from the surface of the wafer W (or from a WFB surface of a reference plate which will be described hereinafter); and the signals from the light reception optical system 60b are supplied to the main control device 13. The Z position of the wafer W is controlled by the main control device 13, via the drive system 25, based upon these signals from the light reception optical system 60b, so as to always to bring the surface of the wafer W to the most optimum plane for image focusing by the projection optical system PL.

The control system mainly comprises the abovementioned main control device 13. This main control device 13 comprises a so called micro computer (or mini computer) which comprises a CPU (central calculating and processing device), a ROM (read only memory), a RAM (random access memory), and the like; and it controls the positional alignment of the reticle R and the wafer W, the stepping of the wafer W, the timing of exposure to light, and the like in an integrated manner, so as to perform the operation of exposure to light in a precise manner. Furthermore, apart from performing positional adjustment of the focal point positions of the reticle alignment microscopes 22A and 22B, this main control device 13 also controls the entire set of devices in an integrated manner. Next, the details of the wafer alignment sensor 27 and the reticle alignment microscopes 22A and 22B will be explained.

For the wafer alignment sensor 27, there is used an image focusing type sensor of a per se known image processing type, such as for example the one disclosed in Japanese Patent Application, First Publication Hei 4-65603, for which an index is provided which functions as a reference for detection, and which detects the position of this index which functions as a reference mark. Upon the wafer stage WST there is provided a reference plate WFB, upon which there may be formed various types of reference marks, such as the wafer reference marks WFM1, WFM2, and WFM3 and the like (wafer fiducial marks), which serve for reticle alignment and base line measurement, as will be described hereinafter. The surface position of this reference plate WFB (its position in the Z direction) is almost the same as the surface position of the wafer W. A wafer alignment sensor 27 detects the positions of the wafer reference marks upon this reference plate WFB and of the wafer alignment marks upon the wafer W, and supplies the results of this detection to the main control device 13. It should be understood that, for this wafer alignment sensor, it would also be acceptable to utilize one of a different type, such as a laser scanning type sensor of a per se known type such as disclosed in, for example, Japanese Patent Application First Publication No. Hei 10-141915 or the like, or a laser interference type sensor or the like.

Each of the reticle alignment microscopes 22A and 22B comprises an alignment illumination system which directs illumination for detection upon the reticle R, a search observation system for implementing comparatively coarse detection, a fine observation system for implementing comparatively fine detection, and the like.

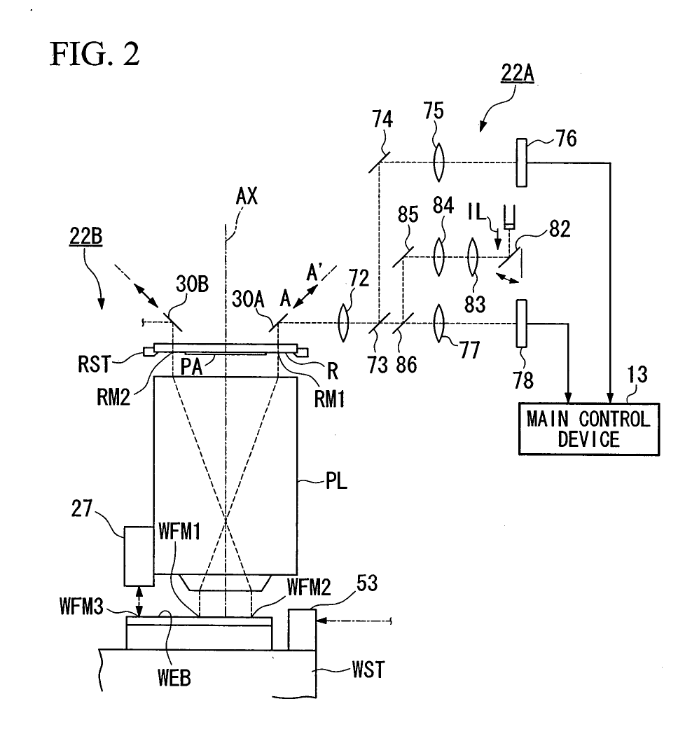

FIG. 2 is a representative figure which shows the structure of the reticle alignment microscope 22A. It should be understood that, since the other one 22B of the reticle alignment microscopes is endowed with the same structure and function as this microscope 22A, its explanation herein will be curtailed.

Referring to FIG. 2, the alignment illumination system uses the exposure light beam (the illumination beam IL; refer to FIG. 1) as illumination for detection, and, after a portion of the rays in this exposure light beam (the illumination beam IL) have been branched off therefrom by a mirror or the like, this portion is conducted within the reticle alignment microscope 22A using an optical fiber, and furthermore this beam is directed upon the reticle R. In more concrete terms, the alignment optical system comprises a movable mirror 82, a collecting lens 83, an image focusing lens 84, a deflection mirror 85, and the like, and is connected via a half mirror 86 to the fine observation system and the search observation system.

The movable mirror 82 is a mirror for changing over the optical path of the illumination beam IL, and it is capable of shifting over between a first position in which it does not reflect the illumination beam IL, and a second position in which it does reflect the illumination beam IL. When the movable mirror 82 is in this first position, it allows an optical path for exposing the wafer to light is provided, while, when the movable mirror 82 is in this second position, it causes an optical path for alignment to be obtained. The position of the movable mirror 82 is selected by the main control device 13.

Furthermore, the inclined mirror 30A is provided so as to be free to shift in the direction shown by the arrow signs A-A′ in FIG. 2 between an illumination position and a sheltered position. When performing alignment using the reticle alignment microscopes 22A and 22B, the main control device 13 drives this inclined mirror 30A by a drive system which is not shown in the figures in the direction of the arrow sign A, so as to fix its position to the illumination position shown in FIG. 2; and, when the alignment procedure has been completed, it drives the inclined mirror 30A via the drive system which is not shown in the figures in the direction shown by the arrow sign A′, so as to shelter it in its predetermined sheltered position in which it does not constitute an obstacle to the light exposure process.

The illumination beam which has passed through the alignment illumination system, along with illuminating the reticle mark RM1 via the inclined mirror 30A, also illuminates the wafer reference mark WFM1 upon the reference plate WFB via the reticle R and the projection optical system PL. The beams which are reflected from the reticle mark RM1 and the wafer reference mark WFM1 are both reflected by the inclined mirror 30A, and these reflected beams are incident into the search observation system and the fine observation system.

The search observation system comprises a search optical system which comprises the inclined mirror 30A, a first objective lens 72, a half mirror 73, a deflection mirror 74, a second objective lens 75, and the like, and a search camera for observation 76. The fine observation system comprises a fine optical system which comprises the inclined mirror 30A, the first objective lens 72, a second objective lens 77, and the like, and a fine camera for observation 78. In this preferred embodiment of the present invention, imaging elements such as CCDs or the like are used for the search camera for observation 76 and the fine camera for observation 78. Furthermore, such a device of low sensitivity is used as the search camera for observation 76, while such a device of high sensitivity is used as the fine camera for observation 78. Yet further, since the magnification ratio for the search optical system is low, the numerical aperture (N.A.) thereof is set to be small, while, since the magnification ratio for the fine optical system is high, the numerical aperture thereof is set to be large. The image signals from the search camera for observation 76 and the fine camera for observation 78 (i.e. the photoelectrically converted signals therefrom) are supplied to the main control device 13.

With the exposure device 10 of this preferred embodiment of the present invention which is endowed with the above described structure, when performing position determination (alignment) of the reticle R, the movable mirror 82 is set to its second position by the main control device 13, and the reticle mark RM1 of the reticle R is illuminated via the alignment illumination system. The reflected beams from the reticle R and the reference plate WFB are incident into the search camera for observation via the search optical system, and images of the reticle mark RM1 and the wafer reference mark WFM1 are simultaneously focused upon the light reception surface of the search camera for observation 76. Furthermore, the reflected beams from the reticle R and the reference plate WFB are incident into the fine camera for observation via the fine optical system, and images of the reticle mark RM and the wafer reference mark WFM1 are simultaneously focused upon the light reception surface of the fine camera for observation 78.

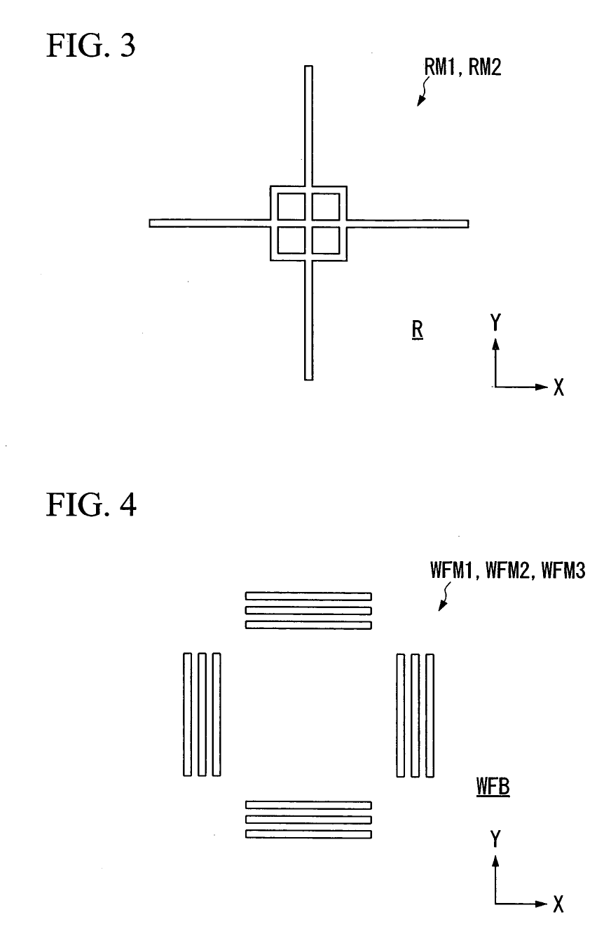

FIG. 3 is a figure showing an example of the structure of the reticle marks RM1 and RM2, and FIG. 4 is a figure showing the structure of the wafer reference marks WFM2, WFM2, and WFM3. The actual shapes of these reticle marks RM and these wafer reference marks WFM are not specifically limited, however, as shown in these figures, it is desirable for them to be two dimensional marks such that, from them, it is possible to detect the direction and the amount of positional deviation in two dimensions.

The reticle marks RM1 and RM2 (hereinafter, according to requirements, these may simply be abbreviated as “the reticle mark or marks RM”) are formed as opaque portions made from chromium in predetermined shapes which are provided upon the surface of the reticle R which is arranged to face downwards, at the outer side of the pattern region thereon; based upon the design data, they are transcribed upon a glass plate which is the parent material for the reticle R, for example by a pattern generator or a so called EB exposure device. In the example shown in FIG. 3, each of the reticle marks RM1 and RM2 is made as a combination of a cross shaped mark element and a rectangular shaped mark element.

The wafer reference marks WFM1, WFM2, and WFM3 (hereinafter, according to requirements, these may simply be abbreviated as “the wafer reference mark or marks WFM”) are formed upon a backing region made from glass by arranging mark elements which are made from chromium. In the example shown in FIG. 4, each of the wafer reference marks WFM, WFM2, and WFM3 includes a mark element in which straight line shaped linear patterns which extend along the Y axis direction are stacked together periodically in the X axis direction, and a mark element in which straight line shaped linear patterns which extend along the X axis direction are stacked together periodically in the Y axis direction. It should be understood that it would also be acceptable to form mark elements from glass upon a backing region made from chromium, as these wafer reference marks WFM. Furthermore although, in this preferred embodiment of the present invention, the reference plate WFB upon which the wafer reference marks WFM1, WFM2, and WFM3 were formed was provided upon the wafer stage WST (refer to FIG. 1), this reference plate WFB could also be positioned in some other position, provided that it is above the stage surface plate BS; for example, it could be upon the wafer holder 52 or upon the shift mirror 53, or the like.

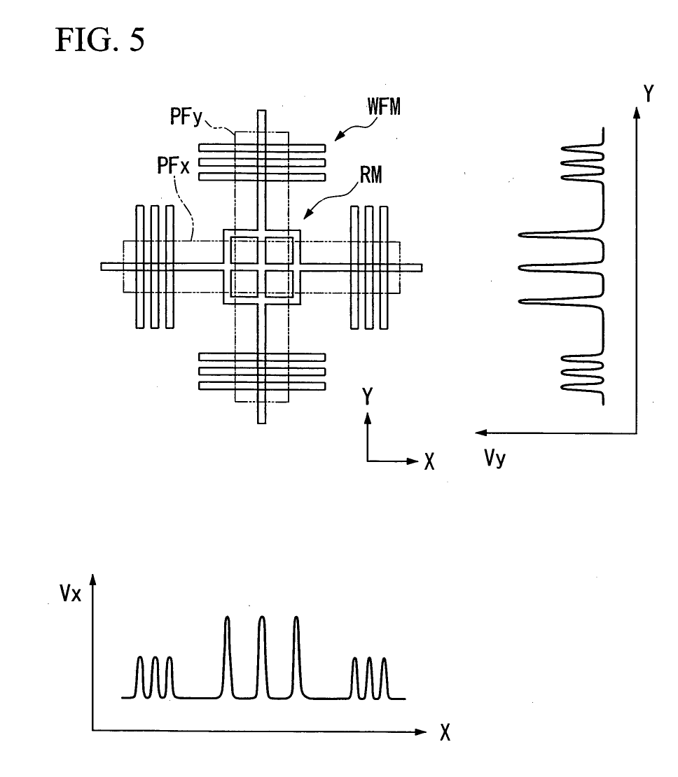

FIG. 5 is a figure showing the images of a reticle mark RM and a wafer reference mark WFM which have been focused into images at the same time upon the light reception surface of the search camera for observation 76 or of the fine camera for observation 78, and also showing the image signal thereof which has been taken by the fine camera for observation 78 (i.e., the signal photoelectrically converted therefrom). It should be understood that the fine camera for observation 78 compresses individual cameras for the X axis and for the Y axis, and the cameras for the X axis and for the Y axis each picks up of an image within a pick up region PFx, PFy which is specified in advance. Since, as has been previously described, in this preferred embodiment of the present invention, each of the mark elements of the reticle mark RM and the wafer reference mark WFM is made from chromium, the beams which are reflected from these mark elements are strong in intensity, and, as a result, the signal strengths in the portions (Vx, Vy) of the signals which correspond to these mark elements are strong, so that, in these portions, signal waveform data are obtained which are strongly convex in shape. When the search camera for observation 76 and the fine camera for observation 78 of the respective reticle alignment microscopes 22A and 22B respectively picks up an image of the reticle mark RM and an image of the wafer reference mark WFM, the photoelectrically converted signals in two dimensions are detected, and are supplied to the main control device 13. When the main control device 13 calculates the relative positional relationship between the reticle mark RM and the wafer reference mark WFM based upon a predetermined algorithm, it adjusts the position and the attitude of the reticle R based upon the result of this calculation (reticle alignment). Furthermore, in the reticle alignment, after having determined the position of the reticle R comparatively coarsely based upon the result of observation by the search observation system, determination of the fine position of the reticle R is performed based upon the result of observation by the fine observation system.

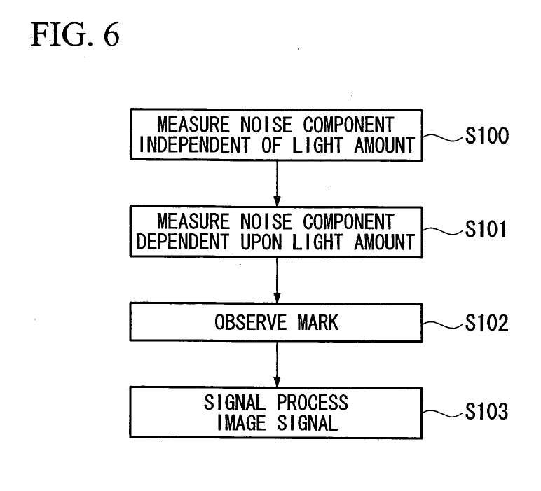

FIG. 6 is a flow chart showing the operation of measurement of the position of a mark which accompanies reticle alignment, and in particular showing an example of a procedure for the operation of measuring the position of a mark which accompanies the process of position determination of the reticle which uses the above described fine alignment system (i.e., the fine alignment procedure).

In the operation of position measurement of this preferred embodiment, before performing signal processing of the signal which has actually been picked up of the mark, the noise which is included in this signal is measured in advance, and the result of this measurement is utilized in the signal processing procedure. In the following, the operation of measuring the position of the mark which accompanies the fine alignment procedure will be explained with reference to FIG. 6.

In this case, as a precondition, after having loaded the reticle R upon the reticle stage RST via the reticle change over device which is not shown in the drawings, the rough position alignment of the reticle R is performed in advance by a search alignment procedure utilizing the search operation system.

First (in the step 100), the component independent of the amount of light of the noise which is included in the image signals of the reticle alignment microscopes 22A and 22B is measured by the main control device 13. The measurement of the component independent of the amount of light of the noise is performed in the situation in which the illumination beam is not being observed by the reticle alignment microscopes 22A and 22B. In concrete terms, the movable mirror 82 of the reticle alignment microscopes 22A and 22B is brought to its first position by the main control device 13, and the signal of the camera for observation 78 is captured in the state in which illumination of the reticle marks RM1 and RM2 is not being performed. It should be understood that the method for obtaining the state in which the illumination beam is not being observed is not limited to the method of controlling the movable mirror 82 as described above; it would also be acceptable to employ some other means for interrupting the optical path of the illumination beam, or it would also be acceptable to control the output of the light source.

By capturing the signal of the camera for observation 78 in the state in which the illumination beam is not being observed by the reticle alignment microscopes 22A and 22B (i.e. by the camera for observation 78), it is possible to measure the component independent of the amount of light of the noise in the reticle alignment microscopes 22A and 22B. This noise component is principally the dark current component of the camera for observation 78. When the above described component of the noise which is independent of the amount of light is measured by the main control device 13, this information is stored.

Next, the component dependent upon the amount of light of the noise which is included in the image signals of the reticle alignment microscopes 22A and 22B is measured (in the step 101) by the main control device 13. This measurement of the component dependent upon the amount of light of the noise is performed by illuminating, with an illumination beam, upon the reticle R and the reference plate WFB, respective mark regions in which a reticle mark RM and a wafer reference mark WFM are formed, and non mark regions which are different from these mark regions, and phicking up images of these non mark regions via the reticle alignment microscopes 22A and 22B. In more concrete terms, based upon design values which have been determined in advance, the reticle stage RST and the wafer stage WST are shifted, via the drive system, by the main control device 13, so as to position the above described non mark regions to the observation positions of the reticle alignment microscopes 22A and 22B, and then the non mark regions upon the reticle R and the wafer reference plate WFB are observed using the reticle alignment microscopes 22A and 22B.

The above described non mark region consists of a material of the same quality as the respective backing regions upon which the mark patterns of the reticle mark R and the wafer reference mark WFM are formed. By capturing the signals which have been observed from the beams which are emitted from these non mark regions, it is possible to measure the components dependent upon the amount of light of the noise by the reticle alignment microscopes 22A and 22B. Since these noise components are generated because the beam passes through the reticle alignment microscopes 22A and 22B, as their causes of generation, for example, there may be suggested interference fringes which are generated by the cover glasses of the cameras for observation 76 and 78, or by the half mirrors 73 and 86, or fluctuations of the sensitivity between the plurality of pixel of the cameras for observation 76 and 78. These types of noise components change almost in proportion to the amount of light in the beams which pass through the reticle alignment microscopes 22A and 22B, and there is a tendency for them to become greater, the greater is the amount of light in the beams. When the above described components of the noise which are dependent upon the amount of light have been measured by the main control device 13, this information is stored.

As for the timing for measurement of the above described noise (of its component which is independent of the amount of light, and of its component which is dependent upon the amount of light), provided that it is before performing signal processing upon the image signals of the marks, it can be executed at any desired timing. For example, it may be executed at predetermined intervals; or it may also be performed each time the device is put into operation. Or it would also be acceptable to measure the environmental factors which exert influence upon the above described noise, and to determine the timing for measuring the noise based upon the results of this measurement. In this case, as an example of an environmental factor which exerts influence upon the noise, there may be cited the atmospheric temperature, the atmospheric pressure, the temperature of the device, and the like. For example, since the above described dark current component (the component which is independent of the amount of light) has a tendency to change according to the temperature, it would also be acceptable periodically to measure the temperature of the camera for observation (of its image pick up device) or a temperature adjacent thereto by utilizing a temperature sensor, and, if the change of temperature has exceeded a predetermined permitted value, to measure the component of the noise which is independent of the amount of light again. In the same manner, for example, there is a possibility that the above described cover glass or half mirror of the camera for observation may be slightly deformed according to the temperature or the atmospheric pressure, and that, in accompaniment therewith, the component of the noise which is independent of the amount of light may change. Due to this, it would also be acceptable periodically to measure the temperatures of these objects or the temperature of their surroundings, and, if the change of temperature has exceeded a predetermined permitted value, to measure the component of the noise which is independent of the amount of light again. In this manner, it becomes possible to perform positional measurement in a stabilized manner over a long time period, by again performing measurement of the noise, based upon the result of measurement of environmental factors which exert an influence upon the noise. It should be understood that it would also be acceptable for it not to be absolutely essential to measure the component which is independent of the amount of light first; it would also be acceptable to measure the component which is dependent upon the amount of light first.

Furthermore, it is also desirable to measure the noise again according to the characteristics of change with the passage of time of its component which is dependent upon the amount of light. In other words, if the component which is dependent upon the amount of light is endowed with the characteristic of changing with the passage of time, although this change amount with the passage of time may be subject to error, if the noise is measured again at a time spacing which is sufficiently small with respect to such change with the passage of time, it is possible to cancel out the error due to the change with the passage of time. And, if there is no change with the passage of time in the component dependent upon the amount of light, it would also be acceptable to utilize the result which is measured one time continuously.

Yet further, it would also be acceptable to perform the measurement of the above described noise (of the component which is independent of the amount of light, and of the component which is dependent upon the amount of light) repeatedly a plurality of times, and to perform the signal processing by utilizing the results of this measurement a plurality of times. In other words, in the measurement of the noise, there is a possibility that noise may occur due to external causes, i.e. not due to direct causes in the reticle alignment microscopes such as random noise in the electrical system and the like. And the measurement error is alleviated by performing this measurement of the above described noise (of the component which is independent of the amount of light, and of the component which is dependent upon the amount of light) repeatedly a plurality of times, and by, for example, averaging the results of this measurement a plurality of times.

Next, the mark is actually observed by the main control device 13, and the image signals thereof are captured (in the step 102). In other words, based upon design values which are determined in advance, the wafer stage WST is shifted by the main control device 13 while monitoring the output of the laser interferometer 56, so as to position the central point of the wafer reference marks WFM1 and WFM2 upon the reference plate WFB upon the optical axis AX of the projection optical system PL. And next, using the reticle alignment microscopes 22A and 22B, along with directing the illumination beam upon the reticle R, the reticle marks RM1 and RM2 upon the reticle R and the wafer reference marks WFM1 and WFM2 upon the reference plate WFB are observed at the same time by the main control device 13.

Next, based upon the result of observing the reticle marks RM1 and RM2 and the wafer reference marks WFM1 and WFM2, and the above described measurement results for the noise, signal processing is performed by the main control device 13 according to a predetermined algorithm, and the relative positional relationship of the two marks RM1 and WFM1 and the relative positional relationship of the two marks RM2 and WFM2 are measured (in the step 103). In this preferred embodiment, it is anticipated to enhance the accuracy of measurement by utilizing the results of measurement of noise in the signal processing for position calculation.

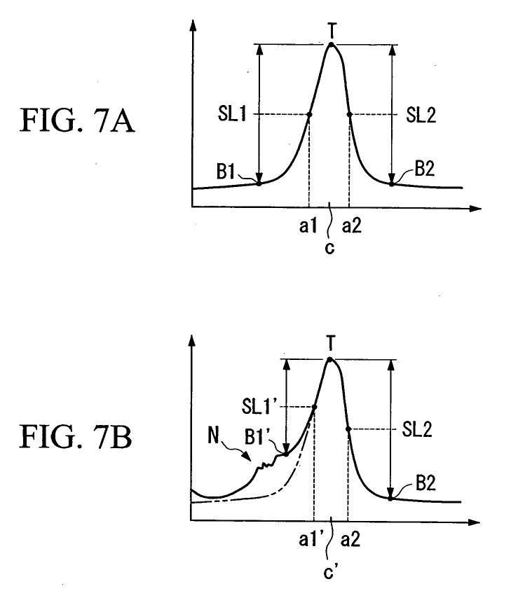

FIGS. 7A and 7B are figures for explanation of the influence which noise included in the image signal exerts upon the measurement of the position of the mark.

FIG. 7A shows the signal waveform of an ideal mark which does not include any noise. When measuring the position of the mark, for example, the amplitude of the signal waveform of the mark is obtained from the intensity of the mark summit portion T of the image signal and the base portion B1 of the side on the left in the figure from the mark summit portion T, and a slice level SL1 is determined upon from this amplitude. Furthermore, the amplitude of the signal waveform of the mark is obtained from the intensity of the mark summit portion T of the image signal and the base portion B2 of the side on the right in the figure from the mark summit portion T, and a slice level SL2 is determined upon from this amplitude. And the point of intersection a1 between the signal waveform on the left side of the mark summit portion T in the figure and the slice level SL1 is obtained, the point of intersection a2 between the signal waveform on the right side of the mark summit portion T in the figure and the slice level SL2 is obtained, and the mid point c between these points of intersection a1 and 12 is taken as being the central point of the mark. It should be understood that it is possible to obtain the relative positional relationship of both of the marks from the central position of the reticle mark and the central position of the wafer reference mark.

By contrast to this, if noise N is included in the image signal as shown in FIG. 7B, then due to the influence of this noise N the base portion on the left side in the figure of the mark summit portion T changes (SL1→SL1′), and, since the point of intersection between the signal waveform on the left side in the figure of the summit portion T and the slice level SL1′ also changes (a1→a1′), accordingly the mid point between the points of intersection also changes from the mid point c between a1 and a2 to the mid point c′ between a1′ and a2, and thus a measurement error occurs. Accordingly, the occurrence of measurement errors is suppressed by eliminating or reducing the noise which is included in the image signal from this image signal (the photoelectrically converted signal) when the marks are actually observed, so that it is possible to anticipate an enhancement of the accuracy of measurement. It should be understood that the above described method of obtaining the central position of the marks is only an example; the present invention is not limited thereby.

The algorithm for signal processing may also, acceptably, be determined according to the size or the level of the noise component which is included in the image signal. By performing the procedure of subtracting from the image signal the component of the noise which is independent of the amount of light, the influence of such noise which is independent of the amount of light, such as the dark current component of the camera for observation 78 and the like, is eliminated or reduced. Furthermore, by performing the procedure of subtracting from the image signal the component of the noise which is dependent upon the amount of light, or of dividing it thereby, the influence of the component of the noise which is dependent upon the amount of light, such as interference of the beams or variations in the sensitivity between the plurality of picture elements of the image pick up device, and the like, is eliminated or reduced. It should be understood that, since the component of the noise which is dependent upon the amount of light changes almost proportionally to the amount of light in the beam which is utilized for the pick up of the image, it is possible to correct the influence of this component of the noise which is dependent upon the amount of light more accurately by performing division processing of the component of the noise which is dependent upon the amount of light into the image signal, as compared to the case of performing subtraction processing. By the sequence of position measurement operation explained above, even if noise is included in the image signal, the influence of this noise may be corrected for, so that it is possible to measure the relative positional relationship between the reticle marks and the wafer reference marks with good accuracy.

It should be understood that, as an initial setting for the reticle R, it is possible to perform positional determination of the reticle R with respect to the projection optical system PL, in other words to perform the reticle alignment, based upon the result of measurement of the above described relative positional relationship.

Furthermore, at the same time as this relative positional measurement, by observing the wafer reference mark WFM3 upon the reference plate WFB by using the wafer alignment sensor 27, and by measuring the relative positional relationship between the wafer reference mark WFM3 and the index upon the wafer alignment sensor 27, it is possible to calculate the so called base line amount. In other words, since the wafer reference marks WFM1, WFM2, and WFM3 upon the reference plate WFB are each formed in a position according to a design positional relationship which is determined upon in advance, from the arrangement information according to design and the relative positional relationship which has been obtained by the operations described above, it is possible to calculate the relative distance (the base line amount) between the projection position of the pattern upon the reticle R and the index upon the wafer alignment sensor 27.

After the above described reticle alignment and base line measurement, the positions of the wafer alignment marks which are provided in the plurality of shot regions upon the wafer W are measured by the main control device 13 in sequence using the wafer alignment sensor 27, and the entire shot array data upon the wafer is obtained by the so called EGA (Enhanced Global Alignment) procedure. Furthermore, according to this array data, while positioning the shot regions upon the wafer W, in sequence, so that they are located directly under the projection optical system PL (i.e. at the light exposure position), the emission of laser light by the light source 12 is controlled, and exposure to light is performed by the so called step and repeat process. It should be understood that, since the EGA procedure and so on are per se known from Japanese Patent Laying Open Publication Showa 61-44429 and the like, the detailed explanation thereof herein will be curtailed.

Next, based upon the operation of measurement of the position of the marks which has been explained for the above described preferred embodiment, preferred embodiments of performing signal processing upon the image signals for the marks will be explained in the following.

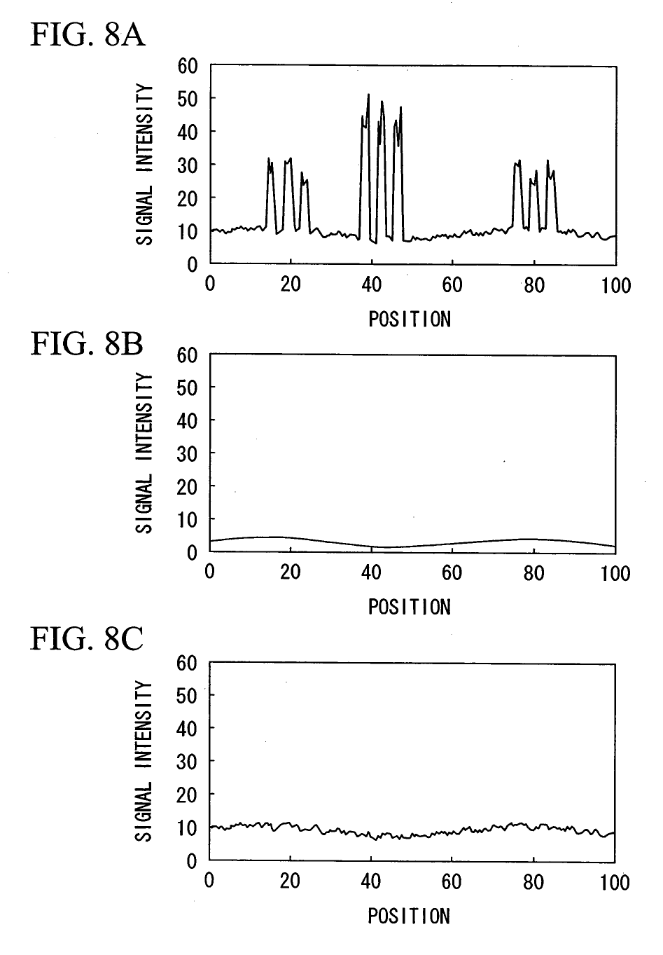

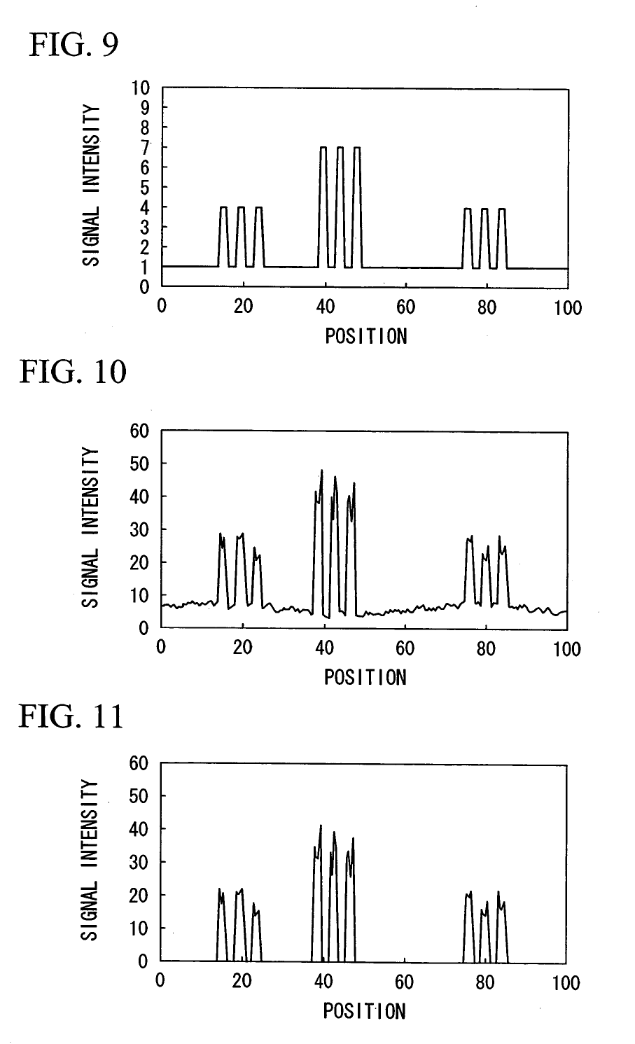

FIG. 8A is a figure showing the image signal (i.e., the signal photoelectrically converted therefrom), when the marks (the reticle mark and the wafer reference mark) have been observed by the camera for observation; FIG. 8B is a figure showing the signal waveform data when the component of the noise included in the image signal shown in FIG. 8A which is independent of the amount of light has been measured; and FIG. 8C is a figure showing signal waveform data when the component of the noise included in the image signal shown in FIG. 8A which is dependent upon the amount of light has been measured. Furthermore, FIGS. 9 through 11 show waveform data resulting from the performance of signal processing upon the image signal shown in FIG. 8A based upon predetermined algorithms.

Here, in the following explanation: the signal waveform data for the mark will be termed Dm; the component of the noise in the signal waveform data which is independent of the amount of light will be termed Dnb; the component of the noise in the signal waveform data which is dependent upon the amount of light will be termed Dna; and the signal waveform data after signal processing has been performed will be termed D.

[Preferred Embodiment 1]

FIG. 9 shows the waveform data upon which signal processing as shown by the Equation (1) below has been performed:
D=(Dm−Dnb)/(Dna−Dnb) (1)

In other words, in this example, as the noise correction algorithm, a division procedure is performed, in which the result of processing is obtained by dividing the result of subtracting the component Dnb of the noise in the signal waveform data which is independent of the amount of light from the component Dna of the noise in the signal waveform data which is dependent upon the amount of light, into the result of subtracting the component Dnb of the noise in the signal waveform data which is independent of the amount of light from the signal waveform data Dm for the mark. As a result, the influence of noise in the image signal for the mark has been well corrected for.

[Preferred Embodiment 2]

FIG. 10 shows the waveform data upon which signal processing as shown by the Equation (2) below has been performed:
D=(Dm−Dnb) (2)

In other words, in this example, as the noise correction algorithm, a subtraction procedure is performed, in which the component Dnb of the noise in the signal waveform data which is independent of the amount of light is subtracted from the signal waveform data Dm for the mark. As a result, the influence of noise (of its component which is independent of the amount of light) in the image signal for the mark has been well corrected for. This example may desirably be employed if the component which is independent of the amount of light included in the noise is large, and the component which is dependent upon the amount of light included in the noise is small. It should be understood that a high throughput can be obtained with this example, since it is possible to manage with an easy subtraction procedure, as compared to the procedure of the algorithm which is specified by the above described Equation (1).

[Preferred Embodiment 3]

FIG. 11 shows the waveform data upon which signal processing as shown by the Equation (3) below has been performed:
D=(Dm−Dna) (3)

In other words, in this example, as the noise correction algorithm, a subtraction procedure is performed, in which the component of the noise in the signal waveform data which is dependent upon the amount of light is subtracted from the signal waveform data Dm for the mark. As a result, the influence of noise (of its component which is independent of the amount of light) [sic] in the image signal for the mark has been well corrected for. This example may desirably be employed if the component which is dependent upon the amount of light included in the noise is large, and the component which is independent of the amount of light included in the noise is small. It should be understood that a high throughput can be obtained with this example as well, since it is possible to manage with an easy subtraction procedure, as compared to the procedure of the algorithm which is specified by the above described Equation (1).

In this manner, with any one of these preferred embodiments, the influence of noise in the image signal for the mark is desirably corrected for. Due to this, it is possible to anticipate an enhancement of the accuracy of positional measurement for the mark by using this processed waveform data, and it is accordingly possible to perform the light exposure procedure with good accuracy.

It should be understood that the algorithm for noise correction is not to be considered as being limited to the above described Equations (1) through (3). For example, it would also be acceptable to perform signal processing as in the Equation (4) below:
D=(Dm/Dna) (4)

In other words, as the algorithm for correcting for the noise, it will also be acceptable to perform a division procedure in which the component of the noise which is dependent upon the amount of light is divided into the signal waveform data (Dm) for the mark.

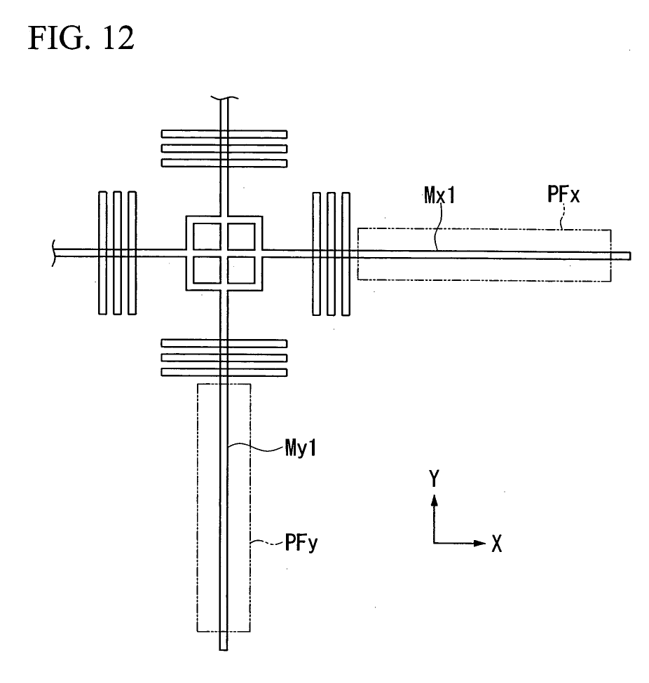

FIG. 12 is a figure showing an example of another preferred embodiment of mark position measurement operation.

In this preferred embodiment, when measuring the component of the noise which is dependent upon the amount of light, the observation of non mark regions which was shown for the above described preferred embodiments is not performed; rather, among a plurality of mark elements which are included in the mark, those mark elements which are not included in the object of measurement are illuminated with the illumination beam, and the component of the noise which is dependent upon the amount of light is measured from the result of this observation.

In other words, as shown in FIG. 12, when measuring the position in the X axis direction, the observation region PFx which includes only the mark element Mx1 which extends in the X axis direction and which constitutes an object which is not to be measured is illuminated, and the component of the noise which is dependent upon the amount of light is measured from the result of this observation. Furthermore, when measuring the position in the Y axis direction, the observation region PFy which includes only the mark element My1 which extends in the Y axis direction and which constitutes an object which is not to be measured is illuminated, and the component of the noise which is dependent upon the amount of light is measured from the result of this observation. And the positional information for the X axis direction and the Y axis direction of the mark is measured using these results of measurement of the noise component. If there is some positional dependency upon the non measurement direction in the noise, there is a possibility that, only by observing the non mark region, it is not possible to measure the noise which is generated by the beam which is reflected by the mark element which constitutes an object which is not to be measured. By contrast to this, it is possible more accurately to reflect the influence of the noise in the position measurement by measuring the noise component in a state which is as close as possible to actual measurement of the mark.

By the way, in recent years, in accompaniment with the high density integration of integrated circuits, in other words with the continued miniaturization of their circuit patterns, the requirements with regard to mask technique have become higher, and masks are coming to be utilized which are endowed with various types of characteristics.

Due to this there are cases in which the intensity of the beam which is generated from the mask marks, due to the mask, has become weak, and in which it is not possible to observe the images of the mask marks with sufficient contrast. For example, by contrast to the state of affairs with a so called high reflectivity reticle (a mask) in which the reflectivity of the mask marks for a general type of illumination beam is high and the mask marks are observed with comparatively high contrast, with a low reflectivity reticle or a so called half tone reticle (mask), since the reflectivity of the mask marks for the above type of illumination beam is low, even when an attempt is made to observe the mask marks by using the reflected beams from the mask marks, the intensity of these reflected beams is weak, and there is a tendency that the mask marks will be observed at low contrast. When the contrast at which the mask marks are observed is low, there is a possibility that this will invite deterioration of the accuracy of measurement of the positions of the marks. Furthermore, it is also easy for errors to occur when adjusting the focal state of the observation system with respect to the mask marks.

In relation to this problem, in Japanese Patent Application 2000-375798, which is a patent application made by the applicant of this application previous to this application, an invention for resolving this problem is proposed.

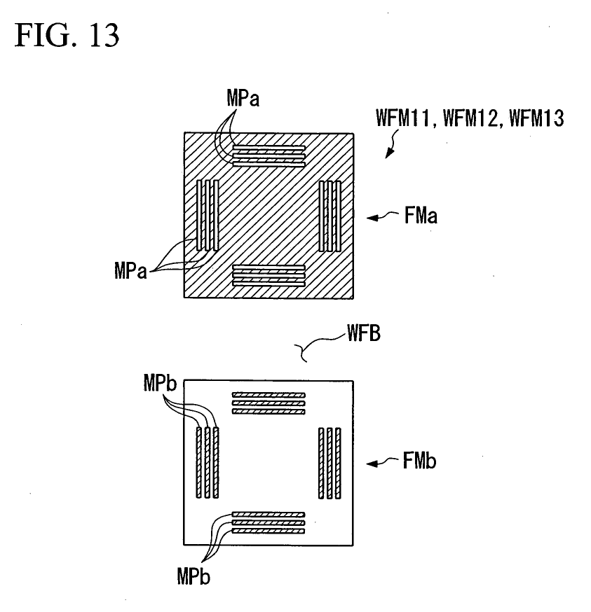

In the invention which is described in said previous patent application (hereinafter termed the previous application), wafer reference marks WFM 11, 12, and 13 as shown in FIG. 13 are used as the wafer reference marks shown in FIG. 4 and described above. The wafer reference marks WFM 11, 12, and 13 include a plurality of marks which have mutually different reflectivities from one another for the above described illumination beam IL. In concrete terms, the wafer reference marks WFM 11, 12, and 13 consist of a first reference mark FMa in which a mark pattern MPa is formed with chromium upon a backing region which is formed from glass, and a second reference mark FMb in which a mark pattern MPb is formed with glass upon a backing region which is formed from chromium. The mark pattern MPa and the mark pattern MPb are made with materials which, as described above, are different from one another, but they are formed in the same shape as one another, and they are disposed upon the reference plate WFB′ as being mutually separated from one another by a predetermined distance in a predetermined direction (for example, in the Y direction). During the above described reticle alignment and measurement of the base line, selectively, the position of one or the other of this plurality of reference marks FMa and FMb is set to be within the observational fields of the reticle alignment microscopes 22A and 22B, and said mark is observed.

Next, with regard to the operation during overlapped exposure to light according to the invention of the above described previous application, the operation particularly in accompaniment with base line measurement will be explained.

In this case, as a precondition, the reticle R is loaded upon the reticle stage RST, and the pattern is already formed upon the wafer W by the processes up to this point, and, along with this pattern, there are also formed wafer alignment marks which are not shown in the figures.

First, the inclined mirrors 30A and 30B are shifted by the main control device 13 based upon design values which are determined in advance, and the positions of the reticle marks RM1 and RM2 upon the reticle R are set to be within their fields of view.

Furthermore, while monitoring the output of the laser interferometer 56, the wafer stage WST is shifted by the main control device 13 based upon design values which are determined in advance, so as to position the central point of the wafer reference marks WFM11, 12, and 13 upon the reference plate WFB upon the optical axis AX of the projection optical system PL. At this time, selectively based upon the reflectivity of the reticle R with respect to the illumination beam IL (the exposure light beam which is used as illumination for detection), the position of any one from among the plurality of reference marks FMa and FMb (refer to FIG. 13) which are formed in these wafer reference marks WFM11, 12, and 13 is set via the drive system 25 by the main control device 13, so as to be within the fields of observation of the reticle alignment microscopes 22A and 22B.

In concrete terms, if for example a reticle of high reflectivity (such as for example one for which the reflectivity of the marks is about 30%) or the like is loaded upon the reticle stage RST, and for example the reflectivity of the reticle marks RM1 and RM2 upon the reticle R is greater than or equal to a predetermined reflectivity, then the drive system 25 shifts the wafer stage WST and selectively sets the position of the first reference mark FMa among the plurality of reference marks FMa and FMb to be within the field of observation. Conversely, if for example a reticle of low reflectivity (such as for example one for which the reflectivity of the marks is about 5% to 10%) or a half tone reticle (such as for example one for which the reflectivity of the marks is about 5% to 10%) or the like is loaded upon the reticle stage RST, and for example the reflectivity of the reticle marks RM1 and RM2 upon the reticle R is less than a predetermined reflectivity, then the drive system 25 selectively sets the position of the second reference mark FMb to be within the field of observation. It should be understood that the reflectivity which is to become the reference for selection, when the reticle mark and the wafer reference mark are observed at the same time, is set so that the contrast of the reticle mark becomes the highest. Furthermore, the information related to the inherent characteristics of the reticle, such as its reflectivity and so on, is stored in advance corresponding to each reticle in the main control device 13.

And, using the reticle alignment microscopes 22A and 22B, along with directing the illumination beam IL upon the reticle R, the reticle marks RM1 and RM2 upon the reticle R and the wafer reference marks WFM11, 12, and 13 upon the reference plate WFB are observed at the same time. At this time, when the reflectivity of the reticle marks RM1 and RM2 upon the reticle R is high, and the first reference mark FMa is disposed within the field of observation of the reticle alignment microscopes 22A and 22B, then, along with comparatively strong beams being emitted from the reticle marks RM1 and RM2 as the reflected beams, a beam of comparatively weak intensity is emitted from the glass backing region for the first reference mark FMa. Due to this, the beams which are emitted from the reticle marks RM1 and RM2 are observed clearly, while the beams which are emitted from the backing regions of the wafer reference marks WFM1 and WFM2 are observed more darkly than the reticle marks RM1 and RM2. As a result, the reticle marks RM1 and RM2 are observed at high contrast. Conversely, when the reflectivity of the reticle marks RM1 and RM2 upon the reticle R is low, and the second reference mark FMb is disposed within the field of observation of the reticle alignment microscopes 22A and 22B, then, along with the intensities of the reflected beams which are emitted from the reticle marks RM1 and RM2 being comparatively weak, a beam of comparatively strong intensity is emitted from the chromium backing region for the second reference mark FMb. Due to this, the beams which are emitted from the reticle marks RM1 and RM2 are observed darkly, while the beams which are emitted from the backing regions of the wafer reference marks WFM1 and WFM2 are observed more clearly than the reticle marks RM1 and RM2. In other words, in this case as well the reticle marks RM1 and RM2 are observed at high contrast.

It is desirable to apply the present invention in the case of the previously applied for invention as explained above as well. In other words, it is considered to be beneficial to measure in advance both the component of the noise for the first reference mark FMa of FIG. 13 which is dependent upon the amount of light, and also the component of the noise for the second reference mark FMb which is dependent upon the amount of light, and to correct the signal, according to which of the first reference mark FMa and the second reference mark FMb is selected, by selectively using one or the other of these two components of noise dependent upon the amount of light which have been stored in advance.

Furthermore, with an actual device, although it may happen that measurement is performed by utilizing a plurality among the wafer reference marks 11, 12, and 13 including the first reference mark FMa and the second reference mark FMb as shown in FIG. 13, there is a possibility that, at this time, manufacturing errors in the marks may exert an influence upon the results of the measurement. In the following it will be supposed that, in order to simplify the explanation, for example, “the first reference mark FMa of the wafer reference mark WFM11” is written as “FM11a”.

For example, if due to errors in the manufacture of the marks, the mutual positional relationship of FM11a, FM12a, and FM13a and the mutual positional relationship of FM11b, FM12b, and FM13b do not agree with one another, then a difference in the results of measurement will arise due to whether the measurement is performed by using the marks FMa which have a glass backing region, or by using the marks FMb which have a chromium backing region.

In order to deal with this problem, it will be adequate to store the difference between the mutual positional relationship of FM11a, FM12a, and FM13a and the mutual positional relationship of FM11b, FM12b, and FM13b as an offset, and to add this offset to the position measurement result, according as to whether the measurement is performed by using the marks FMa with the glass backing, or by using the marks FMb with the chromium backing.

Furthermore, not only do manufacturing errors between the mutual positional relationship between the marks which have a glass backing (i.e. the mutual positional relationship between the marks FM11a, FM12a, and FM13a) and the mutual positional relationship between the marks which have a chromium backing (i.e. the mutual positional relationship between the marks FM11b, FM12b, and FM13b) exert an influence upon the results of measurement of alignment, but also so do manufacturing errors within the marks with a glass backing, i.e. manufacturing errors between the marks FM11a, FM12a, and FM13a themselves.

For example, although four of the mark patterns MPa are shown in FIG. 13, with regard to the spacing of the two mutually confronting mark patterns MPa, it may happen that, with the spacing for the FMa of the wafer reference mark WFM11 and the FMa of the wafer reference mark WFM12, the spacing is different due to manufacturing errors. Due to this, differences in the measurement results may occur due to performing measurement with one or the other of the wafer reference marks WFM11, 12, and 13.

In order to deal with this problem, it is desirable for the distances between the respective mark patterns FMa of the wafer reference mark WFM11, FMa of the wafer reference mark WFM12, and FMa of the wafer reference mark WFM13 to be measured in advance and stored, and for the measurement result to be corrected using this information as to the distance between the mark patterns which has been stored in advance, according to which of the marks has been used. It should be understood that it is also desirable to handle matters in the same manner with regard to manufacturing errors within the marks which have a chromium backing.

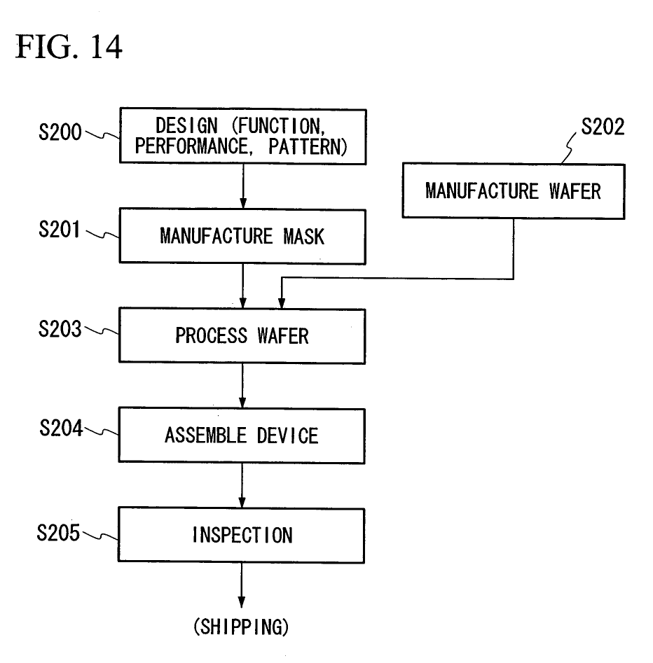

FIG. 14 is a flow chart showing the process of manufacture of a micro device (a semiconductor device) using an exposure device according to a preferred embodiment of the present invention. As shown in FIG. 14, first, in the step S200 (the design step), the functional design of the device (for example, the circuit design of a semiconductor device and so on) are performed, and then pattern design is performed in order to implement this function. Next, in the step S201 (the step of manufacturing the mask), a mask is manufactured based upon the circuit pattern which has been designed. On the other hand, in the step S202 (the step of manufacturing the wafer), a wafer is manufactured using a material such as silicon or the like.

Next, in the step S203 (the step of wafer processing), the actual circuit or the like is formed upon the wafer by a lithographic technique using the mask and the wafer which were prepared in the steps S200 through S202. Next, in the step S204 (the assembly step), the wafer which has been processed in the step S203 is converted into chip form. In this step S204, the processes are included of an assembly process (dicing, bonding), a packaging process (chip enclosure), and the like. Finally, in the step S205 (the testing step), various tests are performed, such as operational check testing of the devices which have been manufactured in the step S204, endurance testing, and the like. After conducting these types of process, the device is completed and is shipped.

Although the explanation has been made in terms of preferred embodiments of the present invention while referring to the drawings, it goes without saying that the present invention is not limited to these particular examples thereof. It is clear that, provided one is a person of ordinary skill in the relevant art, one will be able to conceive of various types of altered examples or modified examples of the present invention, while remaining within the category of technical concept which is included in the range of the patent claims. Accordingly, it will be naturally understood that such variations also belong within the technical scope of the present invention.

For example, it would also be possible to apply the position measurement method according to the present invention to measurement of the positional deviation for assessing whether or not the exposure to light has been correctly performed, or to measurement of the accuracy of drawing of a photo mask upon which an image of the pattern has been drawn.

Furthermore, it would also be acceptable to determine the number, the positions of disposition, and the shapes of the marks which are formed upon the wafer, the reticle, and the reference plates as desired. It would also be acceptable to provide the marks upon the substrate as either one dimensional marks or two dimensional marks.

Yet further, the exposure device to which the present invention is applied is not to be considered as being limited to a method of scanning exposure to light (for example, to the step-and-scan method or the like) in which the mask (the reticle) and the substrate (the wafer) are each relatively shifted with respect to the illumination beam for exposure to light; a method of stationary exposure to light, in which the pattern of the mask is transcribed upon the substrate in a state in which the mask and the substrate are kept almost stationary—for example the step-and-repeat method or the like—would also be acceptable. Moreover, it would also be possible to apply the present invention to an exposure device or the like which utilizes the step-and-stitch method, in which each of the patterns in a plurality of shot regions whose peripheral portions overlap one another are transcribed onto the substrate. Even further, any of the compression type, the equal magnification type, and the magnification type of projection optical system PL may be used; and it would be acceptable to utilize any of a refraction system, a reflection-refraction system, or a reflection system. Yet further, it would also be possible to apply the present invention to an exposure device which does not utilize any projection optical system—for example, to an exposure device which employs a proximity method or the like.

Furthermore, as the illumination light for the light exposure, not only may the exposure device to which the present invention is applied utilize ultraviolet light such as the g line, the i line, KrF excimer laser light, ArF excimer laser light, F2 laser light, Ar2 laser light or the like, but it would also be acceptable for it to utilize, for example, EUV light, X rays, or a charged particle beam such as an electron beam or an ion beam or the like. Yet further, as the light source for the light for exposure, it would also be acceptable to utilize, not only a mercury lamp or an excimer laser or the like, but also a high frequency emission device such as a YAG laser or a semiconductor laser, a SOR, a laser plasma light source, an electron gun, or the like.

Even further, the exposure device to which the present invention is applied is not to be considered as being limited to the manufacture of semiconductor devices; it may also be utilized for the manufacture of a micro device (an electronic device) such as a liquid crystal display element, a display device, a thin film magnetic head, an image pick up device (such as a CCD or the like), a micro machine, a DNA chip, or the like; and it may also be applied to the manufacture of a photo mask or a reticle which is used in an exposure device, or the like.

Moreover, not only can the present invention be applied to these types of exposure device, but it also may be applied to manufacturing other types of device which are utilized in device manufacturing processes (including testing devices and the like). Yet furthermore, if a linear motor is used in the above described wafer stage or reticle stage, it would also be acceptable to utilize either of an air floating type which utilizes air bearings, and a magnetic floating type which utilizes Lorentz force or reactance force. Furthermore, the stage may be of a type which is shiftable along guides, or may be a guideless type which is not provided with guides. Even further, when a planar motor is utilized as the drive system for the stage, it would be acceptable to connect either of a magnet unit (a permanent magnet) and an armature unit to the stage, and to provide the other one of the magnet unit and the armature unit to the side of the surface (the surface plate or base) upon which the stage shifts.

Moreover, the reaction which is generated by the shifting of the wafer stage may be mechanically relieved to the floor (the ground) using a frame member, as described in Japanese Patent Application, First Publication No. Hei 8-166475. The present invention may also be applied to an exposure device which has this sort of structure.

Even further, the reaction which is generated by the shifting of the reticle stage may be mechanically relieved to the floor (the ground) using a frame member, as described in Japanese Patent Application, First Publication No. Hei 8-330224. The present invention may also be applied to an exposure device which has this sort of structure.

Furthermore, the exposure device to which the present invention is applied is manufactured by assembling various types of sub-system which include the various structural elements embraced within the scope of the claims of this patent application, in such a manner as to maintain a predetermined mechanical accuracy, electrical accuracy, and optical accuracy. Before and after this assembly, in order to ensure these types of accuracy, adjustments in order to achieve optical accuracy for the various types of optical system, adjustments in order to achieve mechanical accuracy for the various types of mechanical system, and adjustments in order to achieve electrical accuracy for the various types of electrical system are performed. In the process of assembly of the exposure device from these various types of sub-system, there are included mutual mechanical connections, wiring connections of electrical circuits, piping connections between air pressure circuits, and the like between the various types of sub-system. It goes without saying that, before the process of assembly of the exposure device from these various types of sub-system, there are also processes of assembling each of the sub-systems. When the process of assembling the various types of sub-system into the exposure device has been completed, overall adjustments are performed, and the various types of accuracy of the exposure device as a whole are ensured. It should be understood that it is desirable for the manufacture of this exposure device to be performed in a clean room in which the temperature, the humidity, the cleanliness, and so on are controlled.

1. A position measurement method in which a mark which has been formed upon an object is illuminated with an illumination beam, a beam which is emitted from this mark is picked up via an observation system, and the resultant image signal is signal processed so as to measure positional information which is related to said mark, wherein:
said signal processing includes a step which dividing a value corresponding to a noise which includes component dependent upon the amount of light into a value corresponding to said image signal.

2. A position measurement method as described in claim 1, wherein said noise which includes said component dependent upon the amount of light is measured in advance, before performing said dividing step.

3. A position measurement method as described in claim 2, wherein the measurement of said noise which includes said component dependent upon the amount of light is performed again, according to the characteristic of variation with the passage of time of said component which is dependent upon the amount of light.

4. A position measurement method as described in claim 2, wherein, in the measurement of said noise which includes said component dependent upon the amount of light, a non mark region upon said object which is different from said mark region in which said mark is formed is illuminated with said illumination beam, and this non mark region is picked up via said observation system.

5. A position measurement method as described in claim 2, wherein said mark comprises a plurality of mark elements, and said component which is dependent upon the amount of light is measured by, among said plurality of mark elements, illuminating a region which includes the mark elements other than the object of measurement with said illumination beam.

6. A position measurement method as described in claim 2, wherein an environmental factor which exerts an influence upon said noise is measured, and measurement again of said noise which includes said component dependent upon the amount of light is performed, based upon the result of this measurement.

7. A position measurement method as described in claim 1, wherein said noise in which in said component dependent upon the amount of light is included is the noise generated because of the beam which is emitted from said mark passing through said observation system.

8. A position measurement method as described in claim 7, wherein said observation system includes a mirror.

9. A position measurement method as described in claim 7, wherein said observation system includes an image pick up device, and this image pick up device includes a plurality of picture elements, and a cover glass which protects this plurality of picture elements.

10. A position measurement method as described in claim 1, wherein a step of dividing a second subtraction result which is obtained by subtracting a value corresponding to a component of said noise which is independent of the amount of light from said value corresponding to said noise which includes said component which is dependent upon the amount of light, into the a first subtraction result which is obtained by subtracting said value corresponding to said component of said noise which is independent of the amount of light from said image signal, is included.

11. A position measurement method as described in claim 10, wherein said value corresponding to the component which is independent of the amount of light is measured in advance, in the state in which said illumination beam is not being observed by said observation system, before performing signal processing upon said image signal.

12. An exposure method in which a pattern which has been formed upon a mask is transcribed onto a substrate, wherein:
a mark which has been formed upon said mask or upon said substrate is illuminated with an illumination beam, a beam which is emitted from this mark is picked up via an observation system, a positional information which is related to a position of said mark is determined by dividing a value corresponding to a noise which includes component dependent upon the amount of light into a value corresponding to an image signal which is picked up by said observation system, and the position of said mask or of said substrate is set to a position for exposure to light, based upon the positional information which has been determined.

13. An exposure method as described in claim 12, wherein said noise which includes said component dependent upon the amount of light is measured in advance, before performing signal processing upon said image signal.

14. An exposure method as described in claim 13, wherein the measurement of said noise is performed again, according to the characteristic of variation with the passage of time of said component which is dependent upon the amount of light.

15. An exposure method as described in claim 13, wherein, in the measurement of said noise which includes said component which is dependent upon the amount of light, a non mark region upon said mask or upon said substrate which is different from said mark region in which said mark is formed is illuminated with said illumination beam, and said noise is measured by picking up this non mark region via said observation system.

16. An exposure method as described in claim 13, wherein said mark comprises a plurality of mark elements, and said component of said noise which is dependent upon the amount of light is measured by, among said plurality of mark elements, illuminating a region which includes the mark elements other than the object of measurement with said illumination beam.

17. An exposure method as described in claim 13, wherein an environmental factor which exerts an influence upon said noise is measured, and measurement again of said noise is performed, based upon the result of this measurement.

18. An exposure method as described in claim 12, wherein said noise in which said component dependent upon the amount of light is included is generated because of the beam which is emitted from said mark passing through said observation system.

19. An exposure method as described in claim 18, wherein said observation system includes a mirror.

20. An exposure method as described in claim 18, wherein said observation system includes an image pick up device, and this image pick up device includes a plurality of picture elements, and a cover glass which protects this plurality of picture elements.

21. A position measurement method as described in claim 12, wherein a step of dividing a second subtraction result which is obtained by subtracting a value corresponding to a component of said noise which is independent of the amount of light from said value corresponding to said noise which includes said component which is dependent upon the amount of light, into the a first subtraction result which is obtained by subtracting said value corresponding to said component of said noise which is independent of the amount of light from said image signal, is included.

22. A position measurement method as described in claim 21, wherein said value corresponding to the component which is independent of the amount of light is measured in advance, in the state in which said illumination beam is not being observed by said observation system, before performing signal processing upon said image signal.

23. An exposure device which transcribes a pattern which has been formed upon a mask onto a substrate, comprising:
an observation system which illuminates a body with an illumination beam, and picks up a beam which has been emitted from this body;
a signal processing member which picks up a mark which has been formed upon said mask or upon said substrate via said observation system, signal processes the image signal thereof, and determines positional information which is related to the position of said mark; and
a position determination member which is communicatively connected with the signal processing member and sets the position of said mask or of said substrate to a position for exposure to light based upon said positional information which has been determined;
wherein said signal processing member determines said positional information which is related to the position of said mark by performing a step of dividing a value corresponding to a noise which includes component dependent upon the amount of light into a value corresponding to said image signal.

24. An exposure device as described in claim 23, wherein said signal processing member measures the noise which includes said component dependent upon the amount of light in advance, before performing signal processing upon said image signal.

25. An exposure device as described in claim 24, wherein said signal processing member performs the measurement of said noise again, according to the characteristic of variation with the passage of time of said component which is dependent upon the amount of light.

26. An exposure device as described in claim 24, wherein said signal processing member determines said component of said noise which is dependent upon the amount of light, based upon the result of picking up, via said observation system, a non mark region upon said mask or upon said substrate which is different from said mark region in which said mark is formed.

27. An exposure device as described in claim 24, wherein said mark comprises a plurality of mark elements, and said signal processing member determines said component of said noise which is dependent upon the amount of light based upon the result of picking up, via said observation system, a region which includes the mark elements, among said plurality of mark elements, other than the object of measurement.

28. An exposure device as described in claim 24, further comprising a measurement member which measures an environmental factor which exerts an influence upon said noise, and wherein said signal processing member performs measurement again of said noise, based upon the result of measurement by said measurement member.

29. An exposure device as described in claim 23, wherein said noise in which said component dependent upon the amount of light is included is the noise which is generated because of the beam which is emitted from said mark passing through said observation system.

30. An exposure device as described in claim 29, wherein said observation system includes a mirror.

31. An exposure device as described in claim 29, wherein said observation system includes an image pick up device, and this image pick up device includes a plurality of picture elements, and a cover glass which protects this plurality of picture elements.

32. An exposure device as described in claim 23, wherein said signal processing member divides a second subtraction result which is obtained by subtracting a value corresponding to a component of said noise which is independent of the amount of light from said value corresponding to said noise which includes said component which is dependent upon the amount of light, into the a first subtraction result which is obtained by subtracting said value corresponding to said component of said noise which is independent of the amount of light from said image signal.

33. An exposure device as described in claim 32, wherein said signal processing member.

34. A method of manufacturing a device, including a process of transcribing onto a substrate a device pattern which is formed upon a mask by using an exposure device as described in claim 12.

35. A method of manufacturing a device, including a process in which a device pattern which is formed upon a mask is transcribed onto a substrate by using an exposure device as described in claim 23.
